(19) United States
(12) Patent Application Publication
(10) Pub. No.: US 2006/0073259 A1
(43) Pub. Date: Apr. 6, 2006

(54) Soy-based rice substitute

(76) Inventor: Kendo Kato, Macon, GA (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/233,906

(22) Filed: Sep. 23, 2005

Related U.S. Application Data
(60) Provisional application No. 60/615,661, filed on Oct. 4, 2004.

(51) Int. Cl. A21D 2/00

(52) U.S. Cl. 426/622

(57) ABSTRACT

The present invention is a soy-based rice substitute comprising soy flour and water and having the appearance of rice grains. The invention also includes a process for preparing the same by intermixing soy flour and water to form a mixture; heating the mixture; kneading the mixture; extruding the mixture in the appearance of rice grains to form a soy-based rice substitute; and drying the soy-based rice substitute. The soy-based rice substitute has an appearance and texture that is similar to that of rice and has a cooking time that is far less than that of rice.

This application claims the priority benefit of U.S. Provisional Application 60/615,661, filed Oct. 4, 2004, which is herein incorporated by reference in its entirety.

### BACKGROUND OF THE INVENTION

(1) Field of the Invention

The present invention relates to a soy-based rice substitute and to a method of preparing the same.

(2) Description of the Related Art

Rice is one of the leading food crops in the world. The grain sustains two-thirds of the world's population and provides 20% of the world's dietary energy supply. In many parts of the world, rice is the most important part of the human diet. It is typically harvested, hulled, cleaned, and dried for storage. It can be polished and marketed as white rice or can be marketed with the bran layer left intact as brown rice. The dry grain can then be steamed or boiled by the consumer to rehydrate and cook it.

Despite its primary importance as a food staple, rice has several disadvantages. Primarily, rice is low in protein and high in starch. As a complex carbohydrate, it is often forbidden on certain weight loss programs that focus on reducing the amount of carbohydrates a person consumes. Additionally, the low protein levels in rice can lead to protein malnutrition in societies where rice is the primary constituent of the diet. Deficiencies in essential amino acids may also result from a diet primarily comprised of rice. For example, lysine is the essential amino acid found in the lowest quantity in rice. Thus, lysine is the limiting amino acid in rice. Lysine is considered essential because it cannot be synthesized by humans and must be obtained through our diet. The human body needs lysine for proper growth and repair of tissues. It is also important in the production of various enzymes, hormones and disease-fighting antibodies. A diet consisting primarily of rice is often deficient in this and other essential amino acids.

The ability to provide a high protein, low carbohydrate rice substitute would be beneficial. Providing such a substitute could allow a diet comprised primarily of rice to be more nutritionally balanced. The lower carbohydrate content of the rice substitute could help to eliminate complex carbohydrates from the diet. The higher protein content in the substitute could provide the nutrients, amino acids, and antioxidants necessary to avoid protein deficiencies. In addition, a suitable rice substitute could provide an alternative for persons that have rice allergies or who cannot obtain rice.

Currently, there are no satisfactory rice substitutes. In the past, attempts to provide substitutes have included substituting foods like spaghetti squash, mashed cauliflower, pearled wheat, or mashed white beans for rice. These food products often have varying tastes, textures, smells, and consistencies when compared to rice. Because many people are apprehensive about eating unfamiliar food products such as these, the acceptance of substitutes for rice has been very limited.

Other rice substitutes are referenced in U.S. Pat. Nos. 4,325,976, 5,609,869, and 5,932,271. U.S. Pat. No. 4,325,976 teaches a reformed rice product, or an “instant rice”, comprised of pregelatinized and ungelatinized flour, sodium chloride, and fat in powder form.

U.S. Pat. No. 5,609,869 to Cox, et al. teaches a vitamin augmented rice composite and a method for preparing it. The reference describes a rice composite comprising ground rice, vitamin, a binding agent, a cross-linking agent, an antioxidant, a moisture barrier agent, and an aqueous agent.

U.S. Pat. No. 5,932,271 to Koide, et al. describes a fabricated rice made with a starch, such as corn starch, waxy corn starch, wheat starch, potato starch or rice starch, whey protein and water. The Koide reference, however, does not teach a rice substitute that is low in carbohydrates. The Koide reference teaches a rice substitute that is between 84 and 94% starch and only 0.1 to 10% whey protein, thus high in carbohydrates and low in protein.

U.S. Pat. No. 6,469,089 to Cohen teaches a soy-based dough and products made from the dough. In this disclosure, from 60 to 90% of full fat soy flour and 10 to 40% starch are combined to make a machineable dough. The reference teaches that there are several drawbacks to producing products from one hundred percent soy. Because soybeans do not contain gluten-forming proteins or starches, high soy content doughs do not bind well, are sticky and are not pliable. Additionally, the reference teaches that one hundred percent soy dough will not machine properly because it sticks to the rollers and wires, and cannot be pressed to uniform thickness. The reference also teaches that the taste and texture of one hundred percent soy products is “mealy”, “chalky”, and unpleasant.

Acceptance of rice substitutes remains very limited. Accordingly, it would be useful to provide a rice substitute that maintains the appearance and mouth feel of rice, that cooks in less time than rice, and that has a higher protein content and lower carbohydrate content than rice.

### SUMMARY OF THE INVENTION

Briefly, therefore, the present invention is directed to a novel soy-based rice substitute that comprises soy flour and water. In an embodiment, the soy flour can be low-fat soy flour. In another embodiment, the present invention is directed to a novel method of preparing a soy-based rice substitute from soy flour and water. The method comprises intermixing soy flour and water, heating the mixture, kneading the mixture, extruding the mixture into the appearance of rice grains to form a soy-based rice substitute, and drying the soy-based rice substitute.

Among the several advantages found to be achieved by the present invention, is that the soy-based rice substitute is high in protein and fiber and is low in carbohydrates. Additionally, the appearance and texture of the rice substitute is similar to rice, thereby reducing or eliminating consumer apprehension of soy products. Advantageously, the cooking time of the rice substitute is less than that of rice. Therefore, a rice substitute with the appearance and texture of rice and with the nutritional benefits of a high-protein, low-carbohydrate diet is provided by the present invention.

### DETAILED DESCRIPTION OF THE PREFERRED EMBODIMENTS

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment.

Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

### Definitions

The term “appearance”, as used herein, refers to the shape, length, width, diameter, size, cohesiveness and/or color.

The terms “texture” or “surface texture”, as used herein refers to the texture of the dried product, the texture of the cooked product, and/or the mouth feel of the cooked product.

### Invention

In accordance with the present invention, it has been discovered that a novel soy-based rice substitute can be prepared from soy flour and water. The present invention has the advantages of having the appearance and texture of rice while maintaining the natural nutritional benefits of soy protein. The cooking time of the present invention is also less than that of rice.

Soybeans are very high in both protein and fiber, and are low in carbohydrates. Soybeans are also high in eight well-balanced essential amino acids, which are necessary for human health. In addition, methionine, and not lysine, is the limiting amino acid in soybeans. Thus, soybeans can help balance the levels of essential amino acids in a rice-based diet. Phytochemicals in soybeans protect the heart against oxidation, inhibit blood clot formation, function as antioxidants and exert anti-inflammatory actions. Soybeans are a good source of calcium, magnesium, lecithin, riboflavin, thiamin, fiber, folate and iron. Soy protein has also been shown to lower LDL cholesterol levels, reduce the risk of heart disease, strengthen bones and prevent bone loss in postmenopausal women, and has even been cited as having a protective role against certain types of cancer. Thus, the inclusion of soy protein in a rice substitute can provide numerous health benefits.

Additionally, the present invention provides a food product that can be prepared and consumed in the same manner as rice, yet does not result in an excessive consumption of complex carbohydrates. This can be extremely beneficial for persons desiring to maintain a low-carbohydrate diet. The present invention also provides an alternative food product for persons that do not have access to rice.

While providing a healthy alternative to rice, the present soy-based rice substitute is provided in a form that reduces or eliminates consumer apprehension about soy products. Because the present invention has the appearance, texture and mouth feel of rice grains, consumers are more comfortable including the rice substitute in their diet.

Prior art inventions have utilized whey protein as a component in fabricated rice products, but there are distinct advantages to the use of soy protein over other forms of protein, such as whey. Soy protein is completely cholesterol and lactose-free, making it is useful for vegetarian and lactose-free diets. Whey protein, on the other hand, is only 95 to 97% lactose free. Soy protein is also more digestible and has a higher availability of essential amino acids than does whey protein. Soy protein additionally has a higher glutamine content than whey protein, which can be important in muscle and immune system function. Thus, the use of soy protein in the present invention has distinct advantages over whey protein.

A further advantage of the present invention is that the soy-based rice substitute has a cooking time which is less than that of rice. While traditional rice may require between 20 and 50 minutes to cook, depending on the particular type of rice, the rice substitute of the present invention cooks in approximately 5 to 8 minutes. Thus, if the present product is cooked by steaming, boiling, or in a rice cooker, it provides a fully cooked rice substitute in an amount of time which is far less than the time required to cook rice.

In an embodiment, the present invention has substantially the same appearance as a grain of rice. The present invention can have the appearance of extra-long grain rice, long grain rice, medium grain rice or short-grain rice. Grain length is typically characterized as follows: extra-long (at least about 7.0 mm), long (in the range of about 6.0-6.99 mm), medium (in the range of about 5.0-5.99 mm), and short (less than about 5.0 mm). The grain shape refers to the grain length to width ratio, and are categorized as slender (ratio greater than about 3.0), medium (ratio in the range of about 2.1 to 3.0), bold (ratio in the range of about 1.1 to 2.0) and round (ratio less than about 1.1). These guidelines are not exact; there is variation among the rice community as to an exact scale with which to judge the rice grains. The length of rice grains is particularly important for classification of grains as well as for consumer preferences among various countries. For example, Saudi Arabia, South Africa, Canada, and the Caribbean are the primary U.S. markets for long grain milled white rice, while Japan is the primary U.S. market for both medium and short grain rice.

The texture of the soy-based rice substitute is also similar to that of rice. The texture of both short and medium grain rice are soft, moist and sticky. The texture of both long grain and extra-long grain rice is firm and fluffy, and preferably not sticky. The soy-based rice substitute of the present invention has substantially the same texture.

The rice substitute of the present invention comprises soy flour and water. Soy flour is made from dehulled and cooked soybeans that have been ground into a fine powder. Various brands of soy flour can be purchased commercially and utilized in the invention. As one example, Archer Daniels Midland Company, in Decatur Ill. provides soy flour which can be purchased commercially. Alternatively, soy flour is available from Soy Beginnings, a subsidiary of Thumb Oilseed Producer's Cooperative, located in Ubly, Mich.

In an embodiment of the present invention, the soy flour can be low-fat soy flour or defatted soy flour. Low-fat soy flour typically has most of the oils removed during processing via the use of a mechanical expeller process. Defatted soy flour typically has all of the oils removed using a chemical process.

A soy flour is considered full fat if it contains about 18% to 20% oil. A soy flour is considered low-fat if it contains about 4.5% to 9% oil. Defatted soy flour typically contains less than about 1 % oil.

In a particular embodiment of the invention, the soy flour can prepared from L-Star soybeans. L-Star soybeans are non-genetically modified hybrid soybeans that have a milder flavor and aroma than common U.S. and Asian-grown soybean varieties. This benefit accrues from the fact that the three lipoxygenase isozymes have been removed from the L-Star soybean by traditional breeding methods. L-Star soybeans are higher in protein and richer in Vitamin E than traditional Japanese, Chinese and U.S. soybeans. Information about L-Star soybeans is located at http://www.I-starsoy.com/L-Star.htm and http://www.fengshuitours.com/Food/LStar10012004.asp. The soy flour prepared from L-Star soybeans can be full fat flour, low-fat flour, or defatted flour.

In another embodiment of the present invention, the soy flour can be used in combination with rice flour. Similarly, low-fat or defatted soy flour can be used in combination with rice flour. Rice flour is made primarily from broken rice grains and is usually ground very finely. Various brands and varieties of rice flour can be utilized in this invention. Some sources for rice flour include Bob's Red Mill Natural Foods, in Milwaukie, Oreg., and Sage V Foods, LLC, located in Los Angeles, Calif. If rice flour is included, it is preferred that the amount of rice flour is from about 10% to about 50% by weight, on a dry basis, of the dry ingredients in the present rice substitute.

In other embodiments, calcium hydroxide and/or Konnyaku powder or paste can be added to the present composition. If used together, they can be optionally intermixed and added to the soy flour and water mixture. Konnyaku powder is made from Amorphophallus konjac, a starchy tuber of the yam family. Preparation of the powder involves peeling, boiling, mashing and drying the large brown roots into a powder. Calcium hydroxide can optionally be added to coagulate the mixture. Alternatively, Konnyaku powder can be purchased commercially. Konnyaku powder is available commercially from many sources, including Intelligent Choice, Inc., located in Valencia, Calif., or Chengdu Sheng Te Meng Konjac Powder Co.,Ltd., located in 4rd Avenue North of Erhuan Road, China.

In certain embodiments of the invention, any ingredient that is not water-soluble or heat-soluble can be added to the mixture during processing, if desired. In particular embodiments, flavorings, seasonings, binders, colorants, preservatives, and/or emulsifiers can be added to the composition during processing.

The preparation of the soy-based rice substitute of the present invention involves a heated extrusion process. In one embodiment, the dry ingredients are introduced into a vessel and intermixed. If soy flour is combined with rice flour, the flours should be thoroughly intermixed to give a homogeneous composition before the addition of other components. If calcium hydroxide and/or Konnyaku powder are utilized, they can be intermixed and then added to the dry mixture in the vessel. Water is then added as a percentage of the dry material in an amount sufficient to create a paste-like consistency upon mixing. In an embodiment, sufficient water is added so that the moisture content of the mixture in the vessel is within the range of about 30% to 60% by weight of the mixture. In another embodiment, the moisture content is within the range of about 40% to 50% by weight of the mixture. In a particular embodiment of the invention, the moisture content can be about 45% by weight of the mixture.

The composition is then heated to a temperature of between about 25° C. and 42° C. while being constantly kneaded. The mixture can then be introduced into an extruder. The extruder can be a twin-screw or a single-screw extruder. The pressure inside the extruder can be between about 2,000 kPa and 5,000 kPa, depending on the ingredients contained therein. The mixture can then be extruded through a die at the exit port of the extruder The die is of a size and shape to provide an extruded product which, after drying, will provide a particle of roughly the same diameter as a rice grain.

The product can be dried in any appropriate dryer, or it can simply be air-dried. For example, a tray dryer, conveyor belt-type dryer, ebulating bed dryer, tumble dryer, or rotating cylinder dryer can be used. In certain embodiments, the product can undergo several runs through a dryer in order to obtain the desired moisture content. In an embodiment, the moisture content of the final product can be in the range of about 8% to 15% by weight. In another embodiment, the moisture content of the final product can be about 12% by weight.

The resulting soy-based rice substitute has a texture and appearance which is similar to that of rice and has a cooking time which is far less than that of rice. The invention has a high protein content and a low carbohydrate content while maintaining the nutritional benefits of soy protein. The rice substitute of the present invention therefore provides a healthy alternative to rice. It can also be used in circumstances where rice is not available or when a low-carbohydrate or high-protein diet is desired.

The following examples describe various embodiments of the invention. Other embodiments within the scope of the claims herein will be apparent to one skilled in the art from consideration of the specification or practice of the invention as disclosed. It is intended that the specification, together with the examples, be considered exemplary only, with the scope and spirit of the invention being indicated by the claims which follow the examples. Unless otherwise indicated, all percentages recited in the examples are given by weight.

### EXAMPLE 1

This example illustrates the preparation of an embodiment of the present invention using low-fat soy flour. Low-fat soy flour prepared from L-Star soybeans was metered into the hopper of a Wenger TX57 twin-screw extruder at a constant rate. Water was added as a percentage of the dry material in an amount sufficient to create a paste-like consistency upon mixing. The moisture content of the mixture in the extruder was 45.31%. The mixture was then heated to a temperature of between about 25° and 35° C. while under constant kneading. The pressure inside the extruder was 2,440 kPa. The mixture was then extruded through a circular die and cut and formed into rice-like pieces by extrusion through a knife or blade. The product was then heated in three separate dryer runs on a conveyor belt-type dryer to a temperature of 70° C. for 6 minutes, then 12 minutes, and then 24 minutes in order to dry the soy-based rice substitute. The moisture content of the mixture after drying was 12.56%.

### EXAMPLE 2

This example illustrates a preparation of the soy-based rice substitute using a combination of low-fat soy flour and rice flour. Low-fat soy flour and rice flour were intermixed in amounts of 60.03% low fat soy flour and 39.97% rice flour. The mixture was then metered into the hopper of a Wenger TX57 twin-screw extruder at a constant rate. Water was added as a percentage of the dry material in an amount sufficient to create a paste-like consistency upon mixing. The moisture content of the mixture in the extruder was 40.40%. The mixture was then kneaded and heated to a temperature of between 25° and 42° C. The pressure inside the extruder was maintained at approximately 4,500 kPa. The mixture was then extruded through a circular die and cut and formed into rice-like pieces by extrusion through a knife or blade. The rice-like product was then heated in three separate dryer runs on a conveyor belt-type dryer to a temperature of 70° C. for 6 minutes, then 12 minutes, and then 24 minutes in order to dry the soy-based rice substitute. The moisture content of the final product was 12.93%.

### EXAMPLE 3

This example illustrates the preparation of a soy-based rice substitute using a combination of low-fat soy flour, water, Konnyaku and calcium hydroxide. Low-fat soy flour was intermixed with Konnyaku and calcium hydroxide and was metered into the hopper of a Wenger TX57 twin-screw extruder at a constant rate. The ingredients were intermixed in amounts of 97.92% low-fat soy flour, 1.96% Konnyaku powder, and 0.12% calcium hydroxide. Water was added as a percentage of the dry material in an amount sufficient to create a paste-like consistency upon mixing. The moisture content of the mixture in the extruder was 46.55%. The mixture was then kneaded and heated to a temperature of between 25° and 35° C. The pressure inside the extruder was maintained at 2,440 kPa. The mixture was then extruded through a circular die and cut and formed into rice-like pieces by extrusion through a knife or blade. The rice-like product was then heated in three separate dryer runs on a conveyor belt-type dryer to a temperature of 70° C. for 6 minutes, then 12 minutes, and then 24 minutes in order to dry the soy-based rice substitute. The moisture content of the soy-based rice substitute was 11.95% after drying.

### EXAMPLE 3

This example illustrates one embodiment of the soy-based rice substitute of the present invention. Table 1 illustrates the nutritional information of the invention expressed per 100 grams.

TABLE 1
Nutritional Information (per 100 g)

| | | |
|---|---|---|
| Water | 13.4 | g |
| Protein | 50.4 | g |
| Lipid | 2.6 | g |
| Ash | 6.0 | g |
| Carbohydrate | 27.6 | g |
| Energy | 335 | Kcal |
| Sodium | 4.0 | mg |
| Calcium | 152.0 | mg |
| Vitamin B₁ | 0.24 | mg |
| Vitamin B₂ | 0.24 | mg |
| Phosphatide | 1.43 | mg |

All references cited in the specification, including without limitation all papers, publications, patents, patent applications, presentations, texts, reports, manuscripts, brochures, books, internet postings, journal articles, periodicals, and the like, are incorporated by reference. The discussion of the references herein is intended to merely summarize the assertions made by their authors and no admission is made that any reference constitutes prior art. Applicants reserve the right to challenge the accuracy and pertinence of the cited references.

In view of the above, it will be seen that the several advantages of the invention are achieved and other advantageous results obtained. As various changes could be made in the above methods and compositions without departing from the cope of the invention, it is intended that all matter contained in the above description and shown in the accompanying drawings shall be interpreted as illustrative and not in a limiting sense. These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the preferred versions contained therein.

What is claimed is:

1. A food product comprising soy flour and water and having the appearance of rice grains.

2. The food product according to claim 1, wherein the soy flour comprises low-fat soy flour.

3. The food product according to claim 1, wherein the soy flour is made from L-Star soybeans.

4. The food product according to claim 1, further comprising rice flour.

5. The food product according to claim 4, wherein the product contains rice flour in the range of from about 10% to 50% by weight on a dry basis.

6. The food product according to claim 1, further comprising one or more selected from the group consisting of flavorings, binder, colorants, preservative, and emulsifiers.

7. The food product according to claim 1, wherein the food product has the appearance of brown rice or polished rice.

8. The food product according to claim 1, further having a texture which is similar to that of rice.

9. The food product according to claim 8, wherein the texture is similar to that of brown rice or polished rice.

10. The food product according to claim 1, further comprising calcium hydroxide.

11. The food product according to claim 10, wherein the amount of calcium hydroxide is from about 0.01% to about 1% by weight.

12. The food product according to claim 10, wherein the amount of calcium hydroxide is from about 0.1% to about 0.2% by weight.

13. The food product according to claim 1, further comprising Konnyaku powder.

14. The food product according to claim 13, wherein the amount of Konnyaku powder is between about 0.1% and 10% by weight.

15. The food product according to claim 13, wherein the amount of Konnyaku powder is between about 1% and 3% by weight.

16. A method of preparing a food product, the method comprising:
a. intermixing soy flour and water to form a mixture;
b. heating the mixture;
c. kneading the mixture;
d. extruding the mixture in the appearance of rice grains to form a soy-based rice substitute; and
e. drying the soy-based rice substitute.

17. The method according to claim 16, wherein the mixture of step (a) has a moisture content in the range of about 30% to 60% by weight of the mixture.

18. The method according to claim 16, wherein the mixture of step (a) has a moisture content in the range of about 40% to 50% by weight of the mixture.

19. The method according to claim 16, wherein the drying step provides a soy-based rice substitute having a moisture content in the range of about 10% to 15% by weight.

20. The method according to claim 16, wherein the drying step provides a soy-based rice substitute having a moisture content of about 12% by weight.
